(19) United States
(12) Patent Application Publication
(10) Pub. No.: US 2024/0180784 A1
(43) Pub. Date: Jun. 6, 2024

(54) HOPPER FOR A PHARMACEUTICAL COUNTER

(71) Applicant: Express Scripts Strategic Development, Inc., St. Louis, MO (US)

(72) Inventor: Robert E. Hoffman, Linden, IN (US)

(21) Appl. No.: 18/521,251

(22) Filed: Nov. 28, 2023

Related U.S. Application Data
(60) Provisional application No. 63/430,096, filed on Dec. 5, 2022.

(51) Int. Cl. A61J 7/02; A61J 1/03

(52) U.S. Cl. CPC A61J 7/02; A61J 1/03

(57) ABSTRACT

A pharmaceutical counter for dispensing precise quantities of pharmaceuticals is disclosed. The pharmaceutical counter includes a holder defining a first interior sized to hold a first plurality of pharmaceuticals. A hopper defines a second interior sized to hold a second plurality of pharmaceuticals. The pharmaceutical counter also includes a counting mechanism that counts precise quantities of pharmaceuticals. The counting mechanism is arranged to receive pharmaceuticals of the first plurality of pharmaceuticals held by the holder and to receive pharmaceuticals of the second plurality of pharmaceuticals held by the hopper.

### CROSS-REFERENCE TO RELATED APPLICATION

This application claims priority to U.S. Provisional Application No. 63/430,096, filed Dec. 5, 2022, the entirety of which is hereby incorporated by reference.

### FIELD

The present disclosure generally relates to pharmaceutical counters, and more particularly to a hopper of a pharmaceutical counter.

### BACKGROUND

Pharmaceutical fulfillment systems process and fill a large number of prescriptions and prescription orders with pharmaceuticals. Such fulfillment systems may include automated dispensing systems that supply a specified quantity of pharmaceuticals to prescription containers. Automated dispensing systems typically include one or more pharmaceutical counters which automatically count and dispense a specific quantity (e.g., 30, 60, 90, etc.) of pharmaceuticals.

### SUMMARY

In one aspect, a pharmaceutical counter for dispensing precise quantities of pharmaceuticals comprises a holder defining a first interior sized to hold a first plurality of pharmaceuticals. A hopper defines a second interior sized to hold a second plurality of pharmaceuticals. A counting mechanism is configured to count precise quantities of pharmaceuticals. The counting mechanism is arranged to receive pharmaceuticals of the first plurality of pharmaceuticals held by the holder and to receive pharmaceuticals of the second plurality of pharmaceuticals held by the hopper.

In another aspect, a pharmaceutical counter for dispensing precise quantities of pharmaceuticals comprises a holder defining a first interior sized to hold a first plurality of pharmaceuticals. A hopper defines a second interior sized to hold a second plurality of pharmaceuticals. A counting mechanism is configured to count precise quantities of pharmaceuticals. A first feed mechanism is arranged to receive said pharmaceuticals of the first plurality of pharmaceuticals from the holder and deliver said pharmaceuticals of the first plurality of pharmaceuticals to the counting mechanism. A second feed mechanism is arranged to receive said pharmaceuticals of the second plurality of pharmaceuticals from the hopper and deliver said pharmaceuticals of the first plurality of pharmaceuticals to the counting mechanism.

In another aspect, a pharmaceutical counter for dispensing precise quantities of pharmaceuticals comprises a holder defining a first interior sized to hold pharmaceuticals. A hopper defines a second interior sized to hold pharmaceuticals. A counting mechanism is configured to count precise quantities of pharmaceuticals. A first feed mechanism is arranged to receive pharmaceuticals from the holder and deliver said received pharmaceuticals to the counting mechanism. A second feed mechanism is arranged to receive pharmaceuticals from the hopper and deliver said received pharmaceuticals to the holder.

Other objects and features of the present disclosure will be in part apparent and in part pointed out herein.

### BRIEF DESCRIPTION OF THE DRAWINGS

FIG. 1 is a perspective of a plurality of conventional pharmaceutical counters arranged in an array;

FIG. 2 is a perspective of a conventional pharmaceutical counter;

FIG. 3 is a side elevation of a pharmaceutical counter according to one embodiment of the present disclosure;

FIG. 4 is a rear elevation of a hopper of the pharmaceutical counter of FIG. 3;

FIG. 5 is a schematic diagram of an exemplary controls system of the pharmaceutical counter;

FIG. 6 is a side elevation of a pharmaceutical counter according to another embodiment of the present disclosure;

FIG. 7 is a perspective of a pharmaceutical counter according to another embodiment of the present disclosure;

FIG. 8 is a perspective of a pharmaceutical counter array according to another embodiment of the present disclosure; and

FIGS. 9A-B are perspectives of a hopper according to another embodiment of the present disclosure.

Corresponding reference characters indicate corresponding parts throughout the drawings.

### DETAILED DESCRIPTION

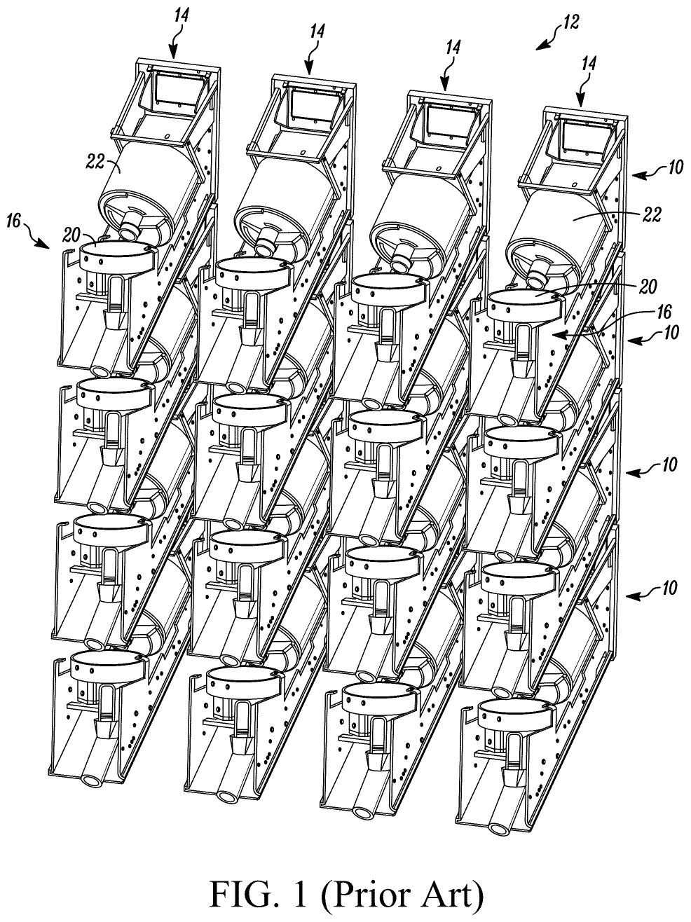

The systems and methods described herein relate to automated dispensing systems, such as high-volume fillers, of pharmaceutical fulfillment systems, such as a high volume pharmaceutical order processing systems, to fulfill a prescription order received by the pharmaceutical order processing system by supplying specified quantities of pharmaceuticals to prescription containers. Further details on pharmaceutical order processing systems, automated dispensing systems, pharmaceutical dispensers and components thereof may be found in U.S. Pat. Nos. 10,303,854 and 9,697,335, the entireties of which are hereby incorporated by reference. Referring to FIG. 1, such automated dispensing systems typically have a plurality of pharmaceutical counters or counting cells 10 configured to count and dispense (e.g., release) the precise or exact quantities (e.g., number) of pharmaceuticals needed to fill a prescription order. The prescription order may include one or more pharmaceuticals (e.g., 30, 60, 90, etc.). The pharmaceuticals dispensed by the pharmaceutical counters 10 may be in the form of pills, capsules, geltabs, tablets, or the like. In an example, the pharmaceuticals include a plurality of discrete, individual units of a medication that is part of a treatment regimen. The plurality of pharmaceutical counters 10 are typically arranged in one or more arrays or banks 12 (broadly, a pharmaceutical counter array), such as the one shown in FIG. 1. In the illustrated embodiment, an array 12 arranged in a 4×4 grid containing sixteen pharmaceutical counters 10 is generally shown. It is understood an array can have more or fewer pharmaceutical counters 10 and can have other arrangements of the pharmaceutical counters. Each pharmaceutical counter 10 counts and dispenses a single type of pharmaceutical to avoid cross contamination with other pharmaceuticals. Accordingly, the more pharmaceutical counters 10 an automated dispensing system has, the greater the number of different types of pharmaceuticals the automated dispensing system can dispense. To this end, the array 12 maximizes the number of pharmaceutical counters 10 that can fit in a given space. All the pharmaceutical counters 10 in the array 12 shown in FIG. 1 are identical.

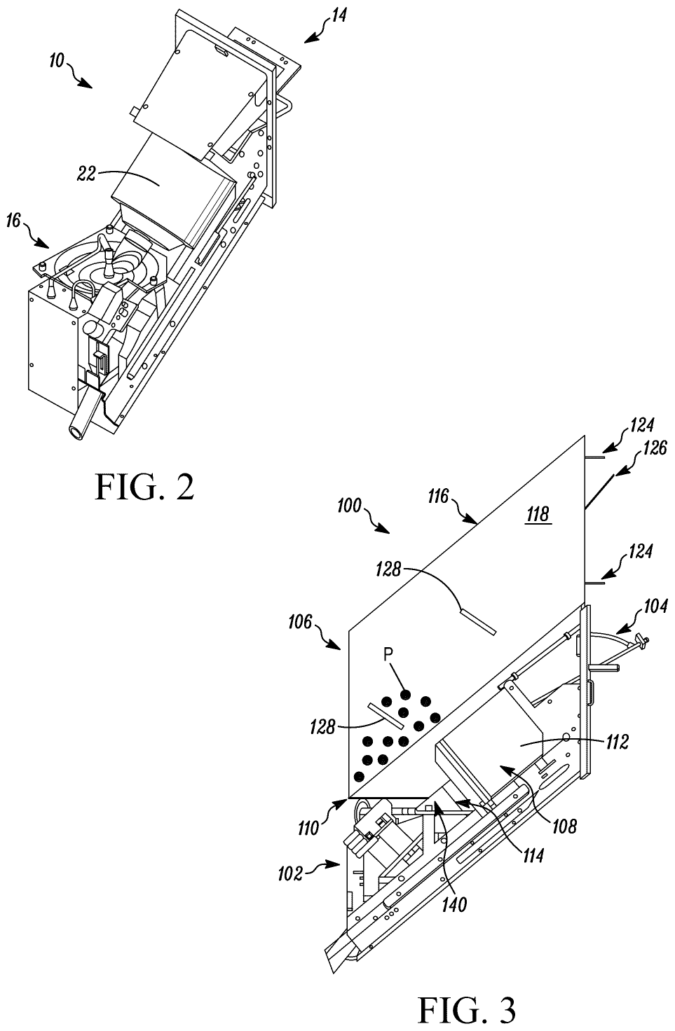

Referring to FIG. 2, each pharmaceutical counter 10 is configured to count and release a specified quantity (e.g., exact counts) of pharmaceuticals (or other plurality of individual solids) to fulfill a prescription order. The pharmaceutical counter 10 includes a conventional hopper 14 and a counting mechanism 16. The conventional hopper 14 is configured to store a plurality of pharmaceuticals for the counting mechanism. The counting mechanism 16 is configured to count and release the exact number of pharmaceuticals needed to fill a prescription order. The conventional hopper 14 has an interior volume of about 4 liters (about 1 gallon). This capacity allows the conventional hopper 14 to hold, on average, approximately 4000 pills or generally all the pharmaceuticals contained in one replenishment container. Of course this number can vary depending on the size of the pills. During operation, the convention hopper 14 generally hold enough pharmaceuticals for about thirty minutes of runtime. Thus, an operator, technician or pharmacists must refill the conventional hopper 14 approximately every thirty minutes. Pharmaceutical counters 10 are generally known and thus a more detailed description herein is omitted. For example, the pharmaceutical counters 10 shown in FIGS. 1 and 2 are Kirby Lester High Volume Counting Cells, although other counters may be used without departing from the scope of the present disclosure. The pharmaceutical counter 10 shown in FIGS. 1 and 2 is a type of Kirby Lester High Volume Counting Cells that include a rotational feed bowl or rotary bowl 22 that feeds a vibratory bowl 20. Other types of pharmaceutical counters and counting mechanisms may be used without departing from the scope of the present disclosure.

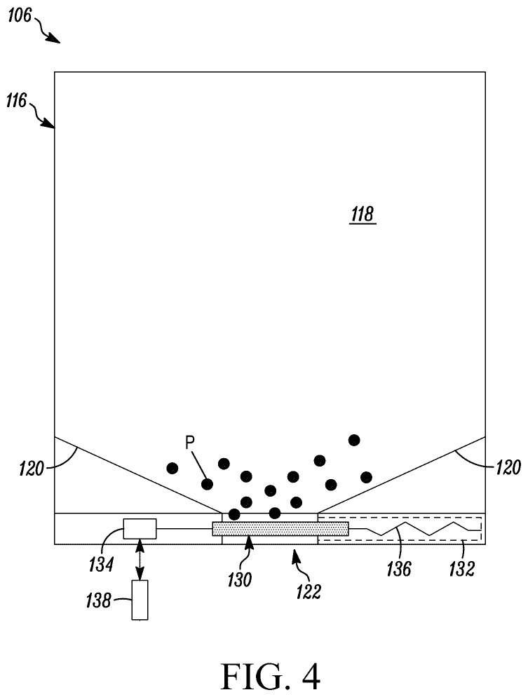

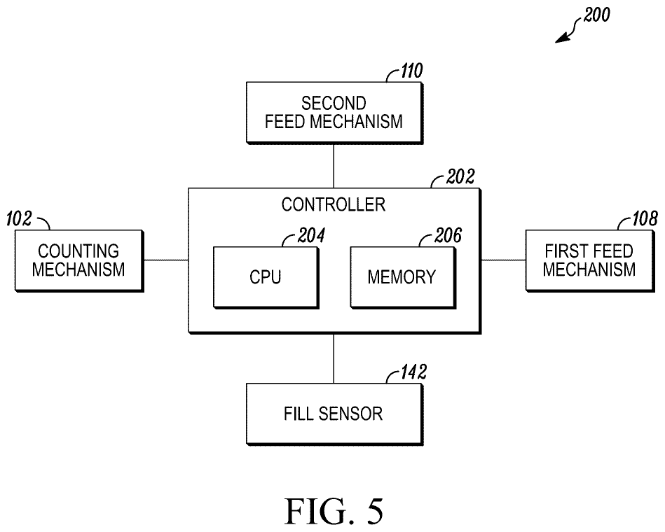

Referring to FIGS. 3 and 4, a pharmaceutical counter according to an embodiment of the present disclosure is generally indicated at 100. Like conventional pharmaceutical counters 10, the pharmaceutical counter 100 of the present disclosure counts and releases a specified quantity (e.g., exact counts) of pharmaceuticals (or other plurality of individual solids) to fulfill a prescription order. The pharmaceutical counter 100 includes a counting mechanism 102, a pharmaceutical holder or receptacle 104, a hopper 106 (broadly, a second pharmaceutical holder or receptacle), a first feed mechanism 108 and a second feed mechanism 110. The counting mechanism 102 is configured to count precise quantities of pharmaceuticals P. In the illustrated embodiment, the counting mechanism 102 is generally identical to the counting mechanism 16 of the conventional pharmaceutical counter 10 shown in FIG. 2, although other configurations of the counting mechanism can be used without departing from the scope of the present disclosure.

The holder 104 includes a housing defining an interior sized to hold a plurality of pharmaceuticals P (e.g., a first plurality of pharmaceuticals). The housing is generally enclosed with opposite front and rear walls, opposite side walls and opposite top and bottom walls. The bottom wall is angled to direct the pharmaceuticals P rearward. The front wall includes a door which allows an operator or pharmacists to load pharmaceuticals into the holder 104 from the front. In the illustrated embodiment, the holder 104 is generally identical to the hopper 14 of the conventional pharmaceutical counter 10 shown in FIG. 2, although other configurations of the holder can be used without departing from the scope of the present disclosure. The counting mechanism 102 is arranged to receive the pharmaceuticals P held by the holder 104. The first feed mechanism 108 is arranged to convey pharmaceuticals P held by the holder 104 toward the counting mechanism 102. In the illustrated embodiment, the first feed mechanism 108 is arranged to receive the pharmaceuticals P from the holder 104 and deliver the pharmaceuticals to the counting mechanism 102. The counting mechanism 102 includes an inlet or opening 114 (e.g., first inlet) sized, shaped and arranged to receive the pharmaceuticals P conveyed by the first feed mechanism 108. The pharmaceuticals P move (e.g., fall) through the inlet 114 and into the vibratory bowl of the counting mechanism 102. The illustrated first feed mechanism 108 comprises a rotary or rotational bowl 112. The rotary bowl 112 (e.g., interior thereof) is in communication with the interior of the holder 104 and the inlet 114 of the counting mechanism. The first feed mechanism 108 includes a prime mover (not shown), such as an electric motor, operatively connected to the rotary bowl 112 for selectively rotating the rotary bowl. As the rotary bowl 112 rotates, pharmaceuticals P flow from the holder 104 into the rotary bowl 112 and then from the rotary bowl into the inlet 114 of the counting mechanism 102. The pharmaceuticals P generally do not flow when the rotary bowl is stationary. In the illustrated embodiment, the rotary bowl 112 is generally identical to the rotary bowl 22 of the conventional pharmaceutical counter 10 shown in FIG. 2, although other configurations of the first feed mechanism can be used without departing from the scope of the present disclosure. Together, the counting mechanism 102, the holder 104, and the first feed mechanism 108 are generally correspond to or are generally identical to the conventional pharmaceutical counters 10.

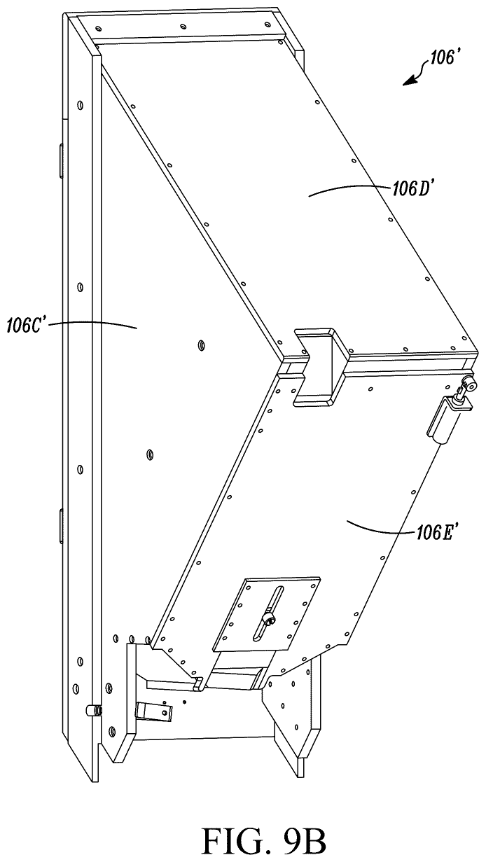

The hopper 106 includes a housing 116 defining an interior 118 sized to hold a plurality of pharmaceuticals P (e.g., a second plurality of pharmaceuticals). The housing 116 is generally enclosed with opposite vertical front and rear walls, opposite vertical side walls, and opposite top and bottom walls. The bottom wall is angled to direct the pharmaceuticals P rearward. The top wall is also angled. The housing 116 also includes angled first and second guide walls 120 (FIG. 4). The interior 118 has an upper portion (e.g., upper end) and a lower portion (e.g., lower end). The walls enclose an interior volume (i.e., the interior 118) in which the pharmaceuticals can be stored. As described at least one wall is vertically oriented, e.g., the front wall, rear wall, a first side wall or a second side wall. At least one wall is angled relative to vertical and to horizontal, e.g., the top wall or the bottom wall. In the illustrated embodiment, the hopper 106 has a generally rhombohedrum shape, although other configurations can be used without departing from the scope of the present disclosure. For example, the hopper 106 can have an irregular polyhedron shape, a triangular prism shape, etc. One example of a generally triangular prism shaped hopper 106 is illustrated generally in FIGS. 9A-B. In this embodiment, the hopper, designated by reference numeral 106′, has a vertical front wall 106A′ (which includes a door), opposite vertical first and second side wall 106B′, 106C′, an angled upper rear wall 106D′, and an angled lower rear wall 106E′. The angled upper and lower rear walls 106D′, 106E′ meet at a joint, forming one corner of the triangular prism shape. Further details of this hopper 106′ are shown and described in U.S. patent application Ser. No. 17/876,897, filed Jul. 29, 2022, the entirety of which is hereby incorporated by reference.

The interior 118 has a volume that is larger than the volume of the conventional hopper 14 and preferably much larger than the volume of the conventional hopper, e.g., at least double. In various embodiments, the volume of the interior 118 is 3×, 4×, 5×, 6×, 7×, etc. the volume of the conventional hopper 14. The volume of the interior 118 is preferably within the inclusive range of about 12 liters (about 3.2 gallons) to about 28 liters (about 7.4 gallons), and more preferably within the inclusive range of about 16 liters (about 4.2 gallons) to about 24 liters (about 6.3 gallons), and more preferably within the inclusive range of about 16 liters (about 4.2 gallons) to about 20 liters (about 5.3 gallons), and more preferably about 18 liters (about 4.8 gallons). Thus, the hopper 106 of the present disclosure is able to hold more pharmaceuticals P than the conventional hopper 14. For example, a hopper 106 of the present disclosure with a volume of about 18 liters can hold approximately 20,000 pharmaceuticals P (depending on pill size) or all the pharmaceuticals contained in five to six replenishment containers. In an example, the hopper 106 is sized to hold a quantity of pharmaceuticals that can fill tens, multiple tens, hundreds, or even multiple hundreds of containers with the correct count of pharmaceuticals P. The larger volume of the hopper 106 of the present disclosure enables the automated dispensing system to be more efficient, by reducing the frequency the hopper 106 (broadly, the pharmaceutical counter 100) need to be refilled compared to the conventional hopper 14 (broadly, the conventional counter 10). This also reduces the pharmaceutical counter's 100 downtime (e.g., the time the pharmaceutical counter is inactive or unable to dispense pharmaceuticals because the hopper needs to be or is being refilled). Moreover, because of the lower amount of downtime, it is easier for a control system of the pharmaceutical order processing systems to schedule and arrange the fulfillment of prescription orders using the pharmaceutical counter 100 of the present disclosure. Accordingly, the pharmaceutical counter 100 of the present disclosure has less downtime and replenishment time. Therefore, the pharmaceutical counter 100 more likely to be ready to dispense pharmaceuticals when needed to fill prescription orders.

The lower portion of the housing 116 defines an outlet 122 in communication with the interior 118 (e.g., the lower portion of the interior). The outlet 122 is sized and shaped to permit pharmaceuticals P held in the interior 118 of the hopper 106 to move therethrough. Specifically, the outlet 122 permits pharmaceuticals to flow toward the counting mechanism 102. The guide walls 120 of the housing 116 slope toward the outlet 122 to direct the pharmaceuticals P toward the outlet. In one embodiment, the hopper 106 includes a selectively adjustable metering gate (not shown) that defines at least a portion of the outlet 122 and can be selectively moved to change the size of the outlet to conform the outlet to different sizes of pharmaceuticals and control the flow rate of the pharmaceuticals therefrom. In one embodiment, a prime mover (such as an electric motor or linear actuator) is operatively connected to the metering gate for moving the metering gate to change the size of the outlet. In this embodiment, a controller of the pharmaceutical counter (described in more detail below) may store metering gate settings or positions based on the pharmaceutical (e.g., pill) size and/or shape. The metering gate settings corresponding to the appropriate size of the outlet for corresponding pharmaceutical sizes and/or shapes. The operator can use a user interface to send a pharmaceutical type signal to the controller, which in turn adjusts the position of the metering gate (according to the metering gate settings) to conform the size of the outlet based on the type of pharmaceutical P in the hopper. The user interface can be part of the pharmaceutical counter or a device remote of the pharmaceutical counter (such as a mobile device (e.g., cellphone, tablet, etc.), computer, and the like). The user interface can have a variety of options (e.g., pharmaceutical types, pharmaceutical sizes, pharmaceutical shapes, etc.) related to the type, size, and/or shape of the pharmaceutical the user can select from to generate the pharmaceutical type signal.

The hopper 106 includes two handles 124 mounted on the front wall. The handles 124 permit an operator to easily remove or mount the hopper from the rest of the pharmaceutical counter 100. The hopper 100 also includes a door 126 in the front wall to permit the operator to fill the interior 118 with the pharmaceuticals P.

The hopper 106 may include one or more supports or baffles 128 disposed in the interior 118 of the housing 116. In the illustrated embodiment, the hopper 106 includes two baffles 128, although more or fewer baffles can be used without departing form the scope of the present disclosure. Each baffle 128 is arranged to support a portion of the plurality of pharmaceuticals P held in the interior 118 of the housing 116. By supporting a portion of the pharmaceuticals P in the interior 118, each baffle 128 reduces the head pressure of the pharmaceuticals at the outlet 122. Without this reduction in head pressure, due to the large number of pharmaceuticals P able to be held by the hopper 106, the pharmaceuticals may not flow properly and/or may block or become jammed at the outlet. The baffles 128 are mounted to the opposite side walls of the housing 116. Preferably, the angle of the baffles 128 (relative to the horizontal) is adjustable to permit the orientation of the baffles to be set for the size of the pharmaceuticals P the hopper 106 will hold. For example, the baffles 128 can be selectively rotatable about an axis of rotation. Further details on the baffles, and pharmaceutical counters and components thereof, can be found in U.S. patent application Ser. No. 17/876,897, filed Jul. 29, 2022, incorporated by reference.

The hopper 106 is removably coupled to the rest of the pharmaceutical counter 100, such as the counting mechanism 102. This allows the hopper 106 to be removed from and reconnected to the rest of the pharmaceutical counter 100, such as to fill the hopper with pharmaceuticals P at a remote location. To keep the pharmaceuticals P contained in the interior 118 of the housing 116 when the hopper 106 is separate from the rest of the pharmaceutical counter 100, the hopper 106 includes a gate 130 (FIG. 4). The gate 130 is movable between a closed position (FIG. 4) and an open position (not shown). In the closed position, the gate 130 blocks the outlet 122 to inhibit the pharmaceuticals P from moving (e.g., flowing) therethrough. In the opening position, the gate 130 does not block the outlet 122 (broadly, may only block a portion of the outlet) to permit the pharmaceuticals to move (e.g., flow) though the outlet. In the illustrated embodiment, the gate 130 generally slides laterally or sideways between the open and closed positions. In the open position, the gate 130 is generally disposed in a gate receiving space 132 of the housing 116. The gate 130 is arranged to automatically move from the closed position toward the open position. Preferably, the gate 130 automatically moves from the closed position toward the open position when the hopper 106 is removably coupled to the rest of the pharmaceutical counter 100. In the illustrated embodiment, the hopper 106 includes a gate retainer 134 and a biasing mechanism 136. The biasing mechanism 136 biases the gate 130 toward the open position. In the illustrated embodiment, the biasing mechanism 136 comprises a spring which pulls the gate 130 toward the open position. Other configurations of the biasing mechanism can be used without departing from the scope of the present disclosure. The gate retainer 134 is arranged to hold the gate 130 in the closed position. In one embodiment, the gate retainer 134 comprises a latch that engages and holds the gate 130 in the closed position. The pharmaceutical counter 100 may include a gate actuator 138. The gate actuator 138 is arranged to move (e.g., pivot) the gate retainer 134 so that the gate retainer releases the gate 130, to permit the gate to move toward the open position under the influence of the biasing mechanism 136. Preferably, the gate actuator 138 is arranged to move the gate retainer 134 to move the gate retainer when the hopper 106 is removably coupled to the rest of the pharmaceutical counter 100 (e.g., the counting mechanism 102) to release the gate 130 and permit the gate to move toward the open position. In one example, the gate actuator 138 may engage the gate retainer 134 to pivot the gate retainer, thereby releasing the gate 130 from the gate retainer. In one embodiment, the gate actuator 128 comprises a stud or tenon that engages the gate retainer 134. The gate actuator 128 may be part of the counting mechanism 102, the second feed mechanism 110, or some other part of the pharmaceutical counter 100. The gate 130 may include a handle (not shown) for an operator to grab to move the gate from the open position back to the closed position. For example, the operator may move the gate 130 to the closed position after removing the hopper 106 from the rest of the pharmaceutical counter 100. Other configurations of the gate system can be used without departing from the scope of the present disclosure. For example, in one embodiment, a prime mover (such as an electric motor or linear actuator) is operatively connected to the gate for moving the gate between the open and closed positions. In this embodiment, a controller of the pharmaceutical counter (described in more detail below) operates the prime mover to move the gate between the open and closed positions. The controller may operate the prime mover by sending start and stop signals, and forward or reverse direction signals. In this embodiment, the pharmaceutical counter may include a proximity sensor or a position sensor arranged to detect when the hopper is coupled to the counting mechanism, with the controller operating the prime mover to move the gate to the open position when the sensor determines the hopper is coupled to the counting mechanism and to move the gate to the closed position when the sensor determines the hopper is separated from the counting mechanism. In another embodiment, the gate also serves as the metering gate (e.g., there is no separate metering gate). In this embodiment, the gate generally adjusts the size of the outlet. For example, the gate may have different open positions corresponding to different amounts for how much (e.g., 70%, 60%, 50%, 40%, 30%, 20%, 10%, 0%) of the outlet is blocked by the gate (when the gate is in the open position), thereby conforming the outlet to the different sizes of pharmaceuticals. In this embodiment, the gate may also be operatively connected to the prime mover, which may control the position of the gate as described above in this paragraph and/or in relation to the metering gate.

Still referring to FIG. 3, the counting mechanism 102 is arranged to receive the pharmaceuticals P held by the hopper 106. The second feed mechanism 110 is arranged to convey pharmaceuticals P held by the hopper 106 toward the counting mechanism 102. In the illustrated embodiment, the second feed mechanism 110 is arranged to receive the pharmaceuticals P from the hopper 106 and deliver the pharmaceuticals to the counting mechanism 102. When the hopper 106 is attached to the rest of the pharmaceutical counter 100, as shown in FIG. 3, the second feed mechanism 110 underlies the outlet 122 of the hopper. In one embodiment, the second feed mechanism 110 may be disposed generally right below or at the outlet 122 and may assist in moving the pharmaceuticals P out of the outlet. The second feed mechanism 110 moves the pharmaceuticals generally from the hopper 106 to the counting mechanism 102. The counting mechanism 102 includes an inlet or opening 140 (e.g., a second inlet) sized, shaped and arranged to receive the pharmaceuticals P conveyed by the second feed mechanism 110. The pharmaceuticals P move (e.g., fall) through the inlet 140 and into the vibratory bowl of the counting mechanism 102. In other words, the counting mechanism 102 includes two inlets 114, 140, one for each feed mechanism 108, 110. In other embodiments, the counting mechanism may include a single inlet for both feed mechanisms.

In the illustrated embodiment, the second feed mechanism 110 comprises a vibratory plate. The vibratory plate may include a pharmaceutical platform or plate along which the pharmaceuticals P move and a vibrator operatively coupled to the pharmaceutical platform for vibrating or shaking the pharmaceutical platform. In one embodiment, the vibrator comprises a prime mover, such as an electric motor, that rotates an eccentric to produce vibrations, although other configurations can be used without departing from the scope of the present disclosure. In an example, a rotary motor drives an eccentric cam to produce the vibratory action of the platform. As the vibrator vibrates the pharmaceutical platform, the pharmaceuticals P move along the pharmaceutical platform from the hopper 106 toward and into the inlet 140 of the counting mechanism 102. In one embodiment, the pharmaceutical platform may be sloped a few degrees (e.g., about 1 or 2 degrees) relative to the horizontal toward the inlet 140 of the counting mechanism 102 to assist in moving the pharmaceuticals P to the counting mechanism. The pharmaceuticals P generally do not flow along the pharmaceutical platform when the pharmaceutical platform is not being vibrated. Other configurations of the second feed mechanism can be used without departing from the scope of the present disclosure. For example, the second feed mechanism may comprise an auger that rotates to move the pharmaceuticals. In this embodiment, the auger could be sloped upward for uphill movement of the pharmaceuticals, such as when the inlet of the counting mechanism is disposed at a higher elevation than the outlet of the hopper.

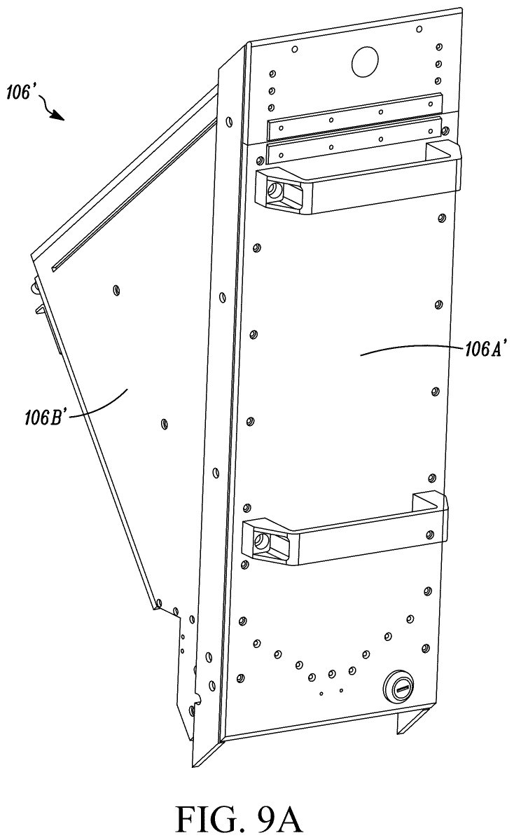

It is appreciated that the first and second feed mechanism 108, 110 are arranged to convey the pharmaceuticals P in different directions (e.g., respective first and second directions). The first feed mechanism 108 conveys the pharmaceuticals P from the holder 104 in one direction and the second feed mechanism 110 conveys the pharmaceuticals from the hopper 106 in another direction. In the illustrated embodiment, the directions the first and second feed mechanisms 108, 110 convey the pharmaceuticals P are generally opposite one another. The first feed mechanism 108 conveys the pharmaceuticals P in a generally rearward direction and the second feed mechanism 110 conveys the pharmaceuticals in a generally forward direction. Other configurations can be used without departing from the scope of the present disclosure. For example, the second feed mechanism can be arranged to convey the pharmaceuticals from the hopper in a generally lateral or sideways direction (broadly, the second feed mechanism is arranged to convey the pharmaceuticals in one of at least two directions (e.g., a generally forward direction or a generally lateral direction)). In this embodiment, instead of the hopper being positioned generally above the counting mechanism 102, the hopper may be positioned to the left side or right side of the counting mechanism. In this embodiment, the second feed mechanism would be reoriented in a corresponding manner to continue transporting pharmaceuticals from the hopper to the counting mechanism. Moreover, in one embodiment, additional hoppers could be added to the pharmaceutical counter utilizing this laterally offset configuration. For example, instead of replacing the hopper above the counting mechanism, an additional hopper (and corresponding second feed mechanism) could be added to left side and/or right side of the counting mechanism or another pharmaceutical counter to further expand pharmaceutical holding capacity, as described below (see FIG. 8).

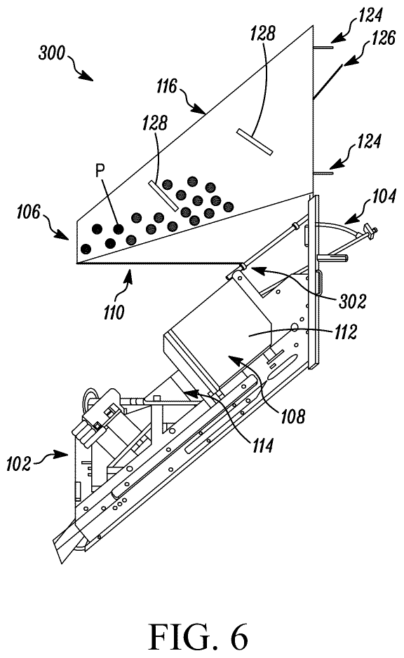

Referring to FIG. 5, an exemplary control system (e.g., pharmaceutical counter control system) of the pharmaceutical counter 100 is generally indicated by reference numeral 200. The control system 200 includes a controller 202 (broadly, a computer) for controlling the operation of the pharmaceutical counter 100. In the illustrated embodiment, the controller 202 is a dedicated controller for the pharmaceutical counter 100 and may be in communication with other components of the pharmaceutical order processing system. In other embodiments, the controller 202 may be an existing controller of the pharmaceutical order processing system. The controller 202 controls and operates the components (e.g., counting mechanism 102, first feed mechanism 108, second feed mechanism 110) of the pharmaceutical counter 100. The controller 202 has control circuity which includes a CPU or processor 204 (e.g., a pharmaceutical counter processor) and RAM or memory 206 (broadly, non-transitory computer readable storage medium). Broadly, the memory 206 includes (e.g., stores) processor-executable instructions for controlling the operation of the pharmaceutical counter 100 and the components thereof. The instructions embody one or more of the functional aspects of the pharmaceutical counter 100 and the components thereof (as described herein), with the processor 202 executing the instructions to perform said one or more functional aspects. The components of the pharmaceutical counter 100 may be in wired or wireless communication with the controller 202. Other configurations of the control system 200 can be used without departing from the scope of the present disclosure.

The controller 202 operates the counting mechanism 102 to dispense the precise quantities of pharmaceuticals P, and the first and second feed mechanisms 108, 110 to supply the counting mechanism with pharmaceuticals. In the illustrated embodiment, the pharmaceutical counter 100 includes a fill sensor 142. The fill sensor 142 is arranged to sense the fill level (e.g., a pharmaceutical fill level) of the pharmaceuticals P in the counting mechanism 102 (specifically, the vibratory bowl 20). Maintaining an appropriate fill level in the vibratory bowl 20 ensures the vibratory bowl will function properly. The fill sensor 142 may comprise any suitable sensor such as a proximity sensor, a position sensor, etc. The fill sensor 142 is in communication with the controller 202. The fill sensor 142 generates a signal based on the sensed or detected fill level of the pharmaceuticals P in the counting mechanism 102. The controller 202 operates the first and second feed mechanisms 108, 110 based on the signal from the fill sensor 142. If the signal from the fill sensor 142 indicates the counting mechanism 102 is sufficiently full of pharmaceuticals P (e.g., the fill level is not low), the controller 202 deactivates the first or second feed mechanisms 108, 110 or keeps the feed mechanisms deactivated. If the signal from the fill sensor 142 indicates the counting mechanism 102 is not sufficiently full of pharmaceuticals P (e.g., the fill level is low), the controller 202 activates the first and/or second feed mechanisms 108, 110. The controller 202 can activate both feed mechanisms 108, 110 simultaneously such that both feed mechanisms deliver pharmaceuticals P to the counting mechanism at the same time or individually such that only one feed mechanism delivers pharmaceuticals at a time.

In one example, using the signal from the fill sensor 142, the controller 202 may conduct a closed loop control routine to maintain an appropriate fill level of pharmaceuticals P within the counting mechanism 102. The controller 202 may monitor (continuously or at periodic intervals) the signal from the fill sensor 142. When the signal from the fill sensor 142 indicates the fill level is low, the controller operates the first and/or second feed mechanisms 108, 110 to move pharmaceuticals P from the first and/or hoppers 104, 106 into the counting mechanism. The controller 202 continues to run the first and/or second feed mechanism 108, 110 until the signal from the fill sensor 142 indicates the fill level is at a sufficient level. The controller 202 then deactivates the first and/or second feed mechanisms 108, 110. Once the signal from the fill sensor 142 indicates the fill level is low again (because the counting mechanism 102 was dispensing pharmaceuticals P), the controller reactivates the first and/or second feed mechanisms 108, 110 and the process repeats.

With reference to FIG. 1, the pharmaceutical counter 100 of the present disclosure can be used in the array 12 of pharmaceutical counters 10. In one embodiment, the pharmaceutical counter 100 of the present disclosure can replace two conventional pharmaceutical counters 10, stacked one on top of the other, in the array 12. In this case, the counting mechanism 102, the first feed mechanism 108 and the holder 104 generally occupy the space in the array 12 previously occupied by the lower pharmaceutical counter 10 of the two replaced conventional pharmaceutical counters and the hopper 106 occupies at least a portion of the space in the array previously occupied by the upper pharmaceutical counter of the two replaced conventional pharmaceutical counters. Preferably, the hopper 106 substantially fills the space previously occupied by the upper conventional pharmaceutical counter 10 that was replaced. Accordingly, the housing 116 of the hopper 106 is sized and shaped to correspond to the size and shape of the conventional pharmaceutical counter 10. For example, the hopper 106 as a width that is generally the same as or corresponds to the width of the conventional pharmaceutical counter 10. The slope of the upper wall of the housing 116 generally matches the slope of the bottom side of the conventional pharmaceutical counter 10. Likewise, the depth of the housing 116 generally matches the depth of the conventional pharmaceutical counter 10. These characteristics allow the hopper 106 to be added to the array 12 by taking the place of an existing pharmaceutical counter 10, while also maximizing the holding capacity of the hopper. Thus, the pharmaceutical counter 100 of the present disclosure is able to fit within an existing array 12 of conventional pharmaceutical counters 10. In other embodiments, the hopper 106 can substantially fills the space previously occupied by more than one (e.g., 2, 3, 4, etc.) conventional pharmaceutical counter 10. In this embodiment, the housing 116 of the hopper 106 can be sized and shaped to correspond to the size and shape of more than one conventional pharmaceutical counter 10. For example, the housing 116 of the hopper 106 can be sized and shaped to substantially fills the space previously occupied by the two conventional pharmaceutical counters 10 stacked one on top of each other in the same column or two conventional pharmaceutical counters placed side-by-side in the same row. It is understood the hopper of the present disclosure can be sized and shaped to substantially fills the space previously occupied by any number and arrangement of conventional pharmaceutical counters 10.

In one method of installing the pharmaceutical counter 100 of the present disclosure in the array 12, the operator removes two conventional pharmaceutical counters 10, that are vertically next to each other, the operator desires to replace with the pharmaceutical counter of the present disclosure. After, the operator installs the pharmaceutical counter 100 of the present disclosure in the space in the array 12 the two conventional pharmaceutical counters 10 that were removed occupied. The pharmaceutical counter 100 substantially fills the space in the array 12 previously occupied by the two conventional pharmaceutical counter 10. Accordingly, the pharmaceutical counter 100 of the present disclosure generally has the same or similar dimensions to two conventional pharmaceutical counters 10. For example, the pharmaceutical counter 100 of the present disclosure has a height that is generally equal to or less than a height of two conventional pharmaceutical counters 10 stacked on top of each other. In another method of installing the pharmaceutical counter 100 of the present disclosure in the array 12, the operator replaces one of the pharmaceutical counters on the top row of the array. In this situation, the process is generally the same as described above, except that the operator does not have to remove a second conventional pharmaceutical counter 10 to accommodate the pharmaceutical counter 100 of the present disclosure.

In another embodiment, the pharmaceutical counter 100 of the present disclosure replaces one of the conventional pharmaceutical counters 10 on one of the sides of the array 12. Only the one conventional pharmaceutical counter 10 is removed. In this case, the pharmaceutical counter 100 has a hopper 106 that is positioned to the side of the counting mechanism 102, as described herein.

In another embodiment, a conventional pharmaceutical counter 10 in the array 12 is modified to become a pharmaceutical counter 100 of the present disclosure. In this embodiment, one conventional pharmaceutical counter 10 is removed from the array and replaced with a hopper 106. The second feed mechanism 110 is also added. The conventional pharmaceutical counter 10 immediately below the removed pharmaceutical counter is modified to work with the hopper 106 and the second feed mechanism 110.

In operation, the counting mechanism 102 of the pharmaceutical counter 100 dispenses the precise quantities of pharmaceuticals P and the first and second feed mechanisms 108, 110 replenish the counting mechanism with pharmaceuticals from the holder 104 and the hopper 106, respectively. When the holder 104 is low or empty, an operator opens the door of the holder and dumps additional pharmaceuticals P into the holder. When the hopper 106 is low or empty, the operator can either use the door 126 to refill the hopper (as described above for the holder 104) or the operator can remove the hopper from the array 12. In this case, the operator disconnects the hopper 106 from the rest of the pharmaceutical counter 100. The operator can then carry the hopper 106 to another location (e.g., room) to fill the hopper with additional pharmaceuticals P using the door 126. Before refilling the hopper 106, the operator may manually move the gate 130 to the closed position, as described herein. After the hopper 106 is refilled, the operator inserts the hopper back into the array 12 and reconnects the hopper to the rest of the pharmaceutical counter 100. During this process, the gate 130 moves back to the open position, as described herein.

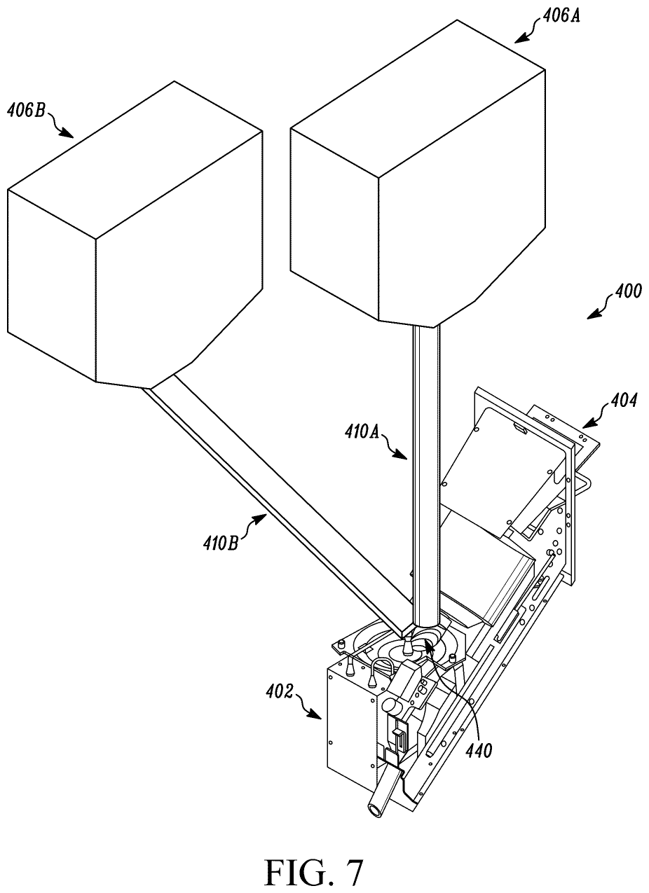

Referring to FIG. 6, another embodiment of a pharmaceutical counter according to the present disclosure is generally indicated at reference numeral 300. The pharmaceutical counter 300 of FIG. 6 is generally analogous to the pharmaceutical counter 100 of FIGS. 3-5 and, thus, for case of comprehension, where similar, analogous or identical parts are used, identical reference numerals are employed. Accordingly, unless clearly stated or indicated otherwise, the above descriptions regarding the pharmaceutical counter 100 of FIGS. 3-5 also apply to the pharmaceutical counter 300 of FIG. 6.

In this embodiment, the pharmaceuticals P held by the hopper 106 move through the holder 104 before moving to the counting mechanism 102. The second feed mechanism 110 is still arranged to receive pharmaceuticals P from the hopper 106, except now the second feed mechanism delivers the pharmaceuticals directly to the holder 104. Broadly, the second feed mechanism 110 is still arranged to convey pharmaceuticals P held by the hopper 106 toward the counting mechanism 102, the pharmaceuticals just first flow through the holder 104. The holder 104 includes an inlet or opening 302 (e.g., a second inlet) sized, shaped and arranged to receive the pharmaceuticals P conveyed by the second feed mechanism 110. In the illustrated embodiment, the inlet 302 is at an upper wall of the holder, but other locations of the inlet can be used without departing from the scope of the present disclosure. The pharmaceuticals P move (e.g., fall) through the inlet 302 and into the interior of the holder 104. Once the pharmaceuticals P from the hopper 106 are in the holder 104, these pharmaceuticals move through the pharmaceutical counter 300 as if they were originally placed in the holder. In one configuration, the second feed mechanism 110 delivers pharmaceuticals P to the holder 104 at generally the same rate the first feed mechanism 108 receives pharmaceuticals from the holder. In one embodiment, the holder 104 includes a fill sensor, similar to fill sensor 142, arranged to detect the fill level within the holder. In this embodiment, the controller 202 operates the second feed mechanism 110 to refill the holder 104 when the fill sensor determines the pharmaceutical fill level in the holder is low. This can be a closed loop routine similar to the closed loop routine described above.

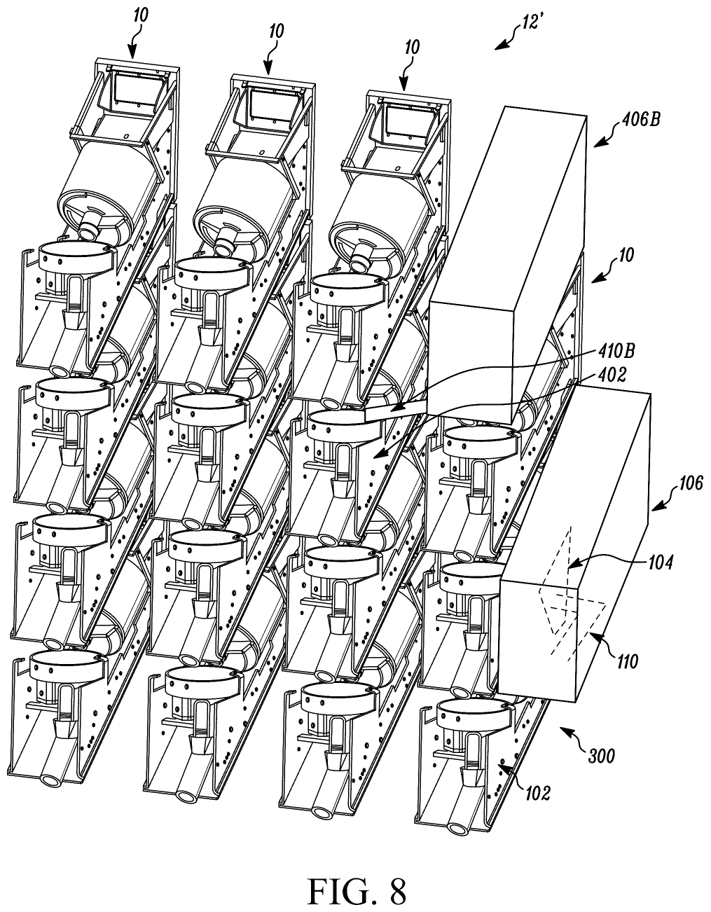

Referring to FIG. 7, another embodiment of a pharmaceutical counter according to the present disclosure is generally indicated at reference numeral 400. The pharmaceutical counter 400 of FIG. 7 is generally analogous to the pharmaceutical counter 100 of FIGS. 3-5 and, thus, for case of comprehension, where similar, analogous or identical parts are used, identical reference numerals are employed. Accordingly, unless clearly stated or indicated otherwise, the above descriptions regarding the pharmaceutical counter 100 of FIGS. 3-5 also apply to the pharmaceutical counter 400 of FIG. 7.

In this embodiment, the pharmaceutical counter 400 includes two hoppers 406A and 406B and the two hoppers are spaced apart from the counting mechanism 402. Accordingly, the two hoppers 406A, 406B are not directly connected to or supported by the counting mechanism 402. Instead, the two hoppers 406A, 406B are connected to and supported by another component, such as a frame (not shown) of the pharmaceutical counter array or another pharmaceutical counter of the pharmaceutical counter array. This configuration expands the pharmaceutical holding capacity of the pharmaceutical counter 400 over conventional counters, as described above, while also eliminating the need to take up the space of two conventional counters in the array. In the illustrated embodiment, one hopper 406A is generally disposed above the counting mechanism 402 and the other hopper 406B is disposed to the side (e.g., left side) of the counting mechanism. Other arrangements (e.g., right side, front, rear, below, etc.) of the hopper(s) relative to the counting mechanism can be used without departing from the scope of the present disclosure. Further, in some embodiments, the pharmaceutical counter may only include one of the two hoppers 406A, 406B or may include more than two hoppers. In the illustrated embodiment, the two hoppers 406A, 406B have a different shape than the hoppers 106 of FIGS. 3 and 6. In this embodiment, the hoppers 406A, 406B may not replace a conventional pharmaceutical counter 10, and therefore do not need to be sized and shaped to correspond to the size and shape of the conventional pharmaceutical counter in order to fit in the array. However, it is understood the one or both of the hoppers 406A, 406B can be of the same shape as the hoppers 106 of FIGS. 3 and 6. The pharmaceutical hopper 400 includes two feed mechanisms 410A and 410B (e.g., two second feed mechanisms), one for each hopper. One feed mechanism 410A is arranged to convey pharmaceuticals P held by hopper 406A toward (e.g., to) the counting mechanism 402 (e.g., inlet 440 thereof). In the illustrated embodiment, feed mechanism 410A comprises an auger that gradually and controllably lowers the pharmaceuticals P from hopper 406A to the counting mechanism 402. The other feed mechanism 410B is arranged to convey pharmaceuticals P held by hopper 406B toward (e.g., to) the counting mechanism 402 (e.g., inlet 440 thereof). In the illustrated embodiment, feed mechanism 410A comprises a vibratory plate, as described above.

Referring to FIG. 8, one embodiment of a pharmaceutical counter array 12′ of pharmaceutical counters implementing the teachings of the present disclosure is generally illustrated. The pharmaceutical counter array 12′ comprises a plurality of conventional pharmaceutical counters 10 and a pharmaceutical counter 400 with a hopper 406B and a feed mechanism 410B that conveys the pharmaceuticals P toward the counting mechanism 402. In this embodiment, the hopper 406B replaced the conventional pharmaceutical counter in the upper right corner of the 4×4 array. The pharmaceutical counter array 12′ also includes a pharmaceutical counter 300 with the hopper 106 disposed along the side of one of the conventional pharmaceutical counters 10 (e.g., mounted to the conventional pharmaceutical counter or the frame) that is disposed directly above the counting mechanism 102. The second feed mechanism 110 of the pharmaceutical counter 300 delivers the pharmaceuticals directly to the holder 104. In this embodiment, the second feed mechanism 110 delivers the pharmaceuticals P to the holder 104 through a side thereof. The second feed mechanism 110 form a generally L-shaped path along which the pharmaceuticals P travel. It is understood the feed mechanisms described herein may have generally any configuration and/or shape in order to deliver the pharmaceuticals. By delivering the pharmaceuticals P directed to the counting mechanism 402 or to the holder 104, the head pressure of the pharmaceuticals at the inlet 114 of the counting mechanism 102, 402 is not sufficiently increased, thereby allowing the pharmaceuticals to flow properly into the counting mechanism while still increasing the storage capacity of the pharmaceuticals. Without this control of the head pressure of the pharmaceuticals, the pharmaceuticals may not flow properly and/or may block or become jammed at the pharmaceuticals move through the pharmaceutical counter (e.g., into the counting mechanism).

The present description discloses embodiments in detail directed to, e.g., systems and methods relating to automated dispensing systems operating on pharmaceuticals. In an example, the pharmaceuticals can be individual solids (i.e., solid exteriors). The embodiments described herein can be extended to operate with non-pharmaceuticals, e.g., individual, solid forms that can be counted (e.g., individualized) and dispensed into containers like pills, capsules, geltabs, tablets, or the like. Some forms can be non-flowable individual items. Some forms can include health supplements, candy, food stuff, and the like.

It is appreciated that the systems and components described herein can be used in other contexts without departing from the scope of the present disclosure.

It is apparent and understood that the elements, features, and/or teachings set forth in each embodiment disclosed herein are not limited to the specific embodiment(s) the elements, features, and/or teachings are described in. Accordingly, it is apparent and understood that the elements, features, and/or teachings described in one embodiment may be applied to one or more of the other embodiments disclosed herein.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

The Title, Field, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field, and Background are not intended to identify key features or essential features of the claimed subject matter, nor is it intended to be used as an aid in determining the claimed subject matter.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved, and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided, and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives, and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A pharmaceutical counter for dispensing precise quantities of pharmaceuticals, the pharmaceutical counter comprising:
a holder defining a first interior sized to hold a first plurality of pharmaceuticals;
a hopper defining a second interior sized to hold a second plurality of pharmaceuticals; and
a counting mechanism configured to count precise quantities of pharmaceuticals, the counting mechanism arranged to receive pharmaceuticals of the first plurality of pharmaceuticals held by the holder and to receive pharmaceuticals of the second plurality of pharmaceuticals held by the hopper.

2. The pharmaceutical counter of claim 1, further comprising a feed mechanism arranged to convey said pharmaceuticals of the second plurality of pharmaceuticals held by the hopper toward the counting mechanism.

3. The pharmaceutical counter of claim 2, wherein the feed mechanism is arranged to convey said pharmaceuticals of the second plurality of pharmaceuticals in a generally forward direction or a generally lateral direction.

4. The pharmaceutical counter of claim 2, wherein the feed mechanism is a second feed mechanism, the pharmaceutical counter further comprising a first feed mechanism arranged to convey said pharmaceuticals of the first plurality of pharmaceuticals held by the holder toward the counting mechanism.

5. The pharmaceutical counter of claim 4, wherein the first feed mechanism is arranged to convey said pharmaceuticals of the first plurality of pharmaceuticals in a first direction, and the second feed mechanism is arranged to convey said pharmaceuticals of the second plurality of pharmaceuticals in a second direction, the first and second directions being different from one another.

6. The pharmaceutical counter of claim 5, wherein the first and second directions are generally opposite one another.

7. The pharmaceutical counter of claim 5, wherein the first direction is a generally rearward direction and the second direction is a generally forward direction or a generally lateral direction.

8. The pharmaceutical counter of claim 7, wherein the second direction is the generally lateral direction.

9. The pharmaceutical counter of claim 4, wherein the first feed mechanism comprises a rotary bowl and the second feed mechanism comprises a vibratory plate.

10. The pharmaceutical counter of claim 4, wherein the counting mechanism includes a first inlet sized, shaped, and arranged to receive said pharmaceuticals of the first plurality of pharmaceuticals conveyed by the first feed mechanism and a second inlet sized, shaped, and arranged to receive said pharmaceuticals of the second plurality of pharmaceuticals conveyed by the second feed mechanism.

11. The pharmaceutical counter of claim 4, wherein the counting mechanism includes an inlet sized, shaped, and arranged to receive said pharmaceuticals of the first plurality of pharmaceuticals conveyed by the first feed mechanism, and wherein the holder includes an inlet sized, shaped and arranged to receive said pharmaceuticals of the second plurality of pharmaceuticals conveyed by the second feed mechanism.

12. The pharmaceutical counter of claim 4, wherein the counting mechanism includes a fill sensor arranged to sense a pharmaceutical fill level in the counting mechanism and configured to generate a signal based on the sensed pharmaceutical fill level, the pharmaceutical counter further comprising a controller configured to operate the first and second feed mechanisms based on the signal.

13. The pharmaceutical counter of claim 12, wherein the controller is configured to operate the first and second feed mechanisms simultaneously.

14. The pharmaceutical counter of claim 1, wherein the hopper is removably coupled to the counting mechanism.

15. The pharmaceutical counter of claim 14, wherein the hopper includes an outlet sized and shaped to permit said pharmaceuticals of the second plurality of pharmaceuticals to move therethrough, the hopper including a gate movable between a closed position and an open position, wherein in the closed position the gate blocks the outlet to inhibit said pharmaceuticals of the second plurality of pharmaceuticals from moving therethrough and wherein in the open position the gate does not block the outlet to permit said pharmaceuticals of the second plurality of pharmaceuticals to move therethrough.

16. The pharmaceutical counter of claim 15, wherein the gate is arranged to automatically move from the closed position toward the open position when the hopper is removably coupled to the counting mechanism.

17. The pharmaceutical counter of claim 16, wherein the hopper includes a gate retainer arranged to hold the gate in the closed position and a biasing mechanism biasing the gate toward the open position.

18. The pharmaceutical counter of claim 17, further comprising a gate actuator arranged to move the gate retainer when the hopper is removably coupled to the counting mechanism to release the gate and permit the gate to move toward the open position.

19. A pharmaceutical counter for dispensing precise quantities of pharmaceuticals, the pharmaceutical counter comprising:
a holder defining a first interior sized to hold a first plurality of pharmaceuticals;
a hopper defining a second interior sized to hold a second plurality of pharmaceuticals;
a counting mechanism configured to count precise quantities of pharmaceuticals;
a first feed mechanism arranged to receive said pharmaceuticals of the first plurality of pharmaceuticals from the holder and deliver said pharmaceuticals of the first plurality of pharmaceuticals to the counting mechanism; and
a second feed mechanism arranged to receive said pharmaceuticals of the second plurality of pharmaceuticals from the hopper and deliver said pharmaceuticals of the first plurality of pharmaceuticals to the counting mechanism.

20. A pharmaceutical counter for dispensing precise quantities of pharmaceuticals, the pharmaceutical counter comprising:
a holder defining a first interior sized to hold pharmaceuticals;
a hopper defining a second interior sized to hold pharmaceuticals;
a counting mechanism configured to count precise quantities of pharmaceuticals;
a first feed mechanism arranged to receive pharmaceuticals from the holder and deliver said received pharmaceuticals to the counting mechanism; and
a second feed mechanism arranged to receive pharmaceuticals from the hopper and deliver said received pharmaceuticals to the holder.
